(19) United States
(12) Patent Application Publication
(10) Pub. No.: US 2022/0000079 A1
(43) Pub. Date: Jan. 6, 2022

(54) ACOUSTICS AUGMENTATION FOR MONOCULAR DEPTH ESTIMATION

(71) Applicant: Ecto, Inc., Atlanta, GA (US)

(72) Inventors: Ming Chen, Atlanta, GA (US); Dmitry Kozachenok, Atlanta, GA (US); Allen Torng, Atlanta, GA (US)

(21) Appl. No.: 16/920,819

(22) Filed: Jul. 6, 2020

(51) Int. Cl. A01K 61/80; G06T 7/55; G06K 9/62; G01S 15/10; G01S 15/89; G06N 3/04; G06N 3/08

(52) U.S. Cl. CPC A01K 61/80; G06T 7/55; G06K 9/6256; G01S 15/10; G06T 2207/20081; G06N 3/04; G06N 3/08; G06T 2207/20084; G01S 15/89

(57) ABSTRACT

A method of monocular depth estimation includes receiving a plurality of monocular images corresponding to images of fish within a marine enclosure and further receiving acoustic data synchronized in time relative to the plurality of images. The plurality of images and the acoustic data are provided to a convolutional neural network (CNN) for training a monocular depth model. The monocular depth model is trained to generate, based on the received plurality of monocular images and the acoustic data, a distance-from-feeder estimate of a vertical biomass center of fish within the marine enclosure.

### BACKGROUND

Aquaculture typically refers cultivation of fish, shellfish, and other aquatic species through husbandry efforts and is commonly practiced in open, outdoor environments. Aquaculture farms often utilize various sensors to help farmers monitor farm operations. Observation sensors enable ability to identify individual animals, track movements, and other behaviors for managing farm operations. Such observation sensors include underwater camera systems for monitoring of underwater conditions. Transmission of imagery allows for viewing and/or recording, allowing aqua-farmers to check the conditions of the tanks, cages, or areas where aquatic species are being cultivated.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a system for implementing acoustics-augmented monocular depth estimation in accordance with some embodiments

FIG. 2 is a diagram illustrating a system with an example network architecture for performing a method of acoustics-augmented monocular depth estimation in accordance with some embodiments.

FIG. 3 is a block diagram of a method for controlling feeding operations based on monocular depth estimation in accordance with some embodiments.

### DETAILED DESCRIPTION

Underwater observation and monitoring of the statuses of aquatic animals in aquaculture is increasingly important for managing growth and health. Such monitoring systems include optical cameras for surveillance and analysis of fish behavior, such as through, for example, fish position tracking on the basis of computer vision techniques to determine a representation of three-dimensional (3D) scene geometry. Recovering the 3D structure of a scene from images is a fundamental task in computer vision that has various applications in general scene understanding—estimation of scene structure allows for improved understanding of 3D relationships between the objects within a scene.

Depth estimation from images have conventionally relied on structure from motion (SFM), shape-from-X, binocular, and multi-view stereoscopic techniques. By way of example, various system utilize triangulation information observed from a scene to determine a depth to one or more surfaces in a scene. One conventional approach to depth sensing is the use of stereo image processing in which two optical sensors with a known physical relationship to one another are used to capture two images of a scene. By finding mappings of corresponding pixel values within the two images and calculating how far apart these common areas reside in pixel space, a computing device determines using triangulation a depth map or depth image containing information relating to the distances of surfaces of objects in the scene.

Aquaculture stock is often held underwater in turbid, low-light conditions and therefore more difficult to observe than animals and plants cultured on land. Additionally, aquaculture environments are associated with a myriad of factors (including fixed sensors with limited fields of view, resource-constrained environments of aquaculture operations, which are often compute limited and further exhibit network bandwidth constraints or intermittent connectivity due to the remote locales of the farms) which decrease the efficacy of conventional depth estimation techniques. Conventional sensor systems are therefore associated with several limitations including decreased accessibility during certain times of the day, unreliable data access, compute constraints, and the like.

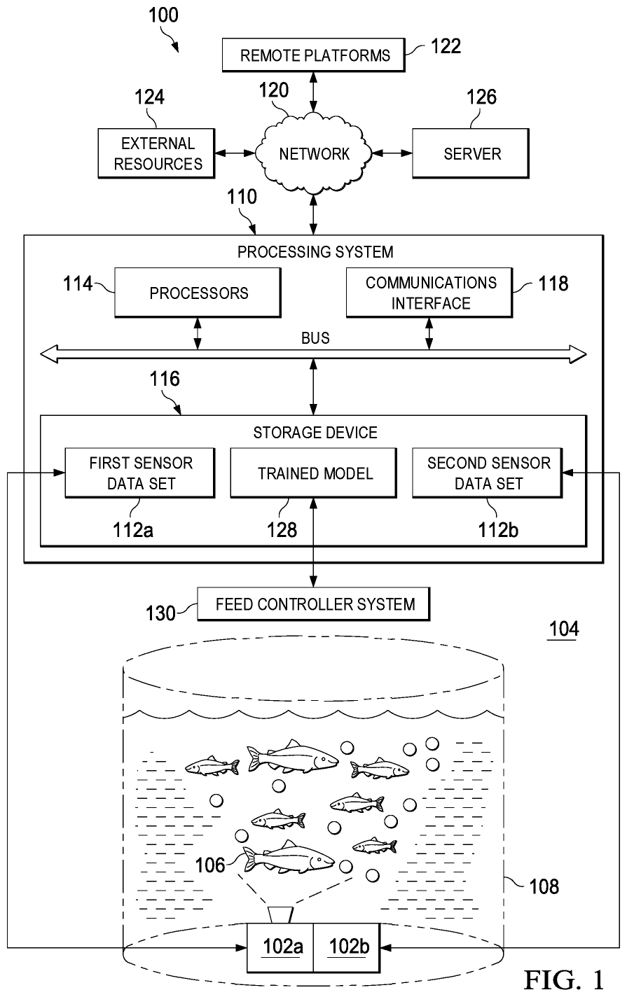

To extend depth estimation capabilities to image sensors that conventionally do not inherently provide depth data (e.g., mono-vision cameras), FIGS. 1-3 describe techniques for monocular depth estimation by training an image-only learned model using acoustics data targets that is capable of determining whether a sufficient number of fish are positioned within a “feeding area” (e.g., water volume directly underneath the feeder) to begin feeding or whether a sufficient number of fish have left the “feeding area” such that feeding should be slowed or stopped. In various embodiments, a method of monocular depth estimation includes receiving a plurality of monocular images corresponding to images of fish within a marine enclosure and further receiving acoustic data synchronized in time relative to the plurality of images. The plurality of images and the acoustic data are provided to a convolutional neural network (CNN) for training a monocular depth model. The monocular depth model is trained to generate, based on the received plurality of monocular images and the acoustic data, a distance-from-feeder estimate of a vertical biomass center of fish within the marine enclosure. By enriching monocular camera images with other synchronized data sources (including acoustics data which provides biomass density and positional data within water column, total individual fish count info, average individual weight, min/max individual weight, etc.), the dimensionality of monocular image data may be improved

FIG. 1 is a diagram of a system 100 for implementing acoustics-augmented monocular depth estimation in accordance with some embodiments. In various embodiments, the system 100 includes one or more sensor systems 102 that are each configured to monitor and generate data associated with the environment 104 within which they are placed. In general, the one or more sensor systems 102 measure and convert physical parameters such as, for example, moisture, heat, motion, light levels, and the like to analog electrical signals and/or digital data.

As shown, the one or more sensor systems 102 includes a first sensor system 102a for monitoring the environment 104 below the water surface. In particular, the first sensor system 102a is positioned for monitoring underwater objects (e.g., a population of fish 106 as illustrated in FIG. 1) within or proximate to a marine enclosure 108. In various embodiments, the marine enclosure 108 includes a net pen system, a sea cage, a fish tank, and the like. Such marine enclosures 108 may include a circular-shaped base with a cylindrical structure extending from the circular-shaped base to a ring-shaped structure positioned at a water line, which may be approximately level with a top surface of the water surface.

In general, various configurations of an enclosure system may be used without departing from the scope of this disclosure. For example, although the marine enclosure 108 is illustrated as having a circular base and cylindrical body structure, other shapes and sizes, such as rectangular, conical, triangular, pyramidal, or various cubic shapes may also be used without departing from the scope of this disclosure. Additionally, the marine enclosure 108 in various embodiments is constructed of any suitable material, including synthetic materials such as nylon, steel, glass, concrete, plastics, acrylics, alloys, and any combinations thereof.

Although primarily illustrated and discussed here in the context of fish being positioned in an open water environment (which will also include a marine enclosure 108 of some kind to prevent escape of fish into the open ocean), those skilled in the art will recognize that the techniques described herein may similarly be applied to any type of aquatic farming environment and their respective enclosures. For example, such aquatic farming environments may include, by way of non-limiting example, lakes, ponds, open seas, recirculation aquaculture systems (RAS) to provide for closed systems, raceways, indoor tanks, outdoor tanks, and the like. Similarly, in various embodiments, the marine enclosure 108 may be implemented within various marine water conditions, including fresh water, sea water, pond water, and may further include one or more species of aquatic organisms.

As used herein, it should be appreciated that an underwater “object” refers to any stationary, semi-stationary, or moving object, item, area, or environment in which it may be desirable for the various sensor systems described herein to acquire or otherwise capture data of. For example, an object may include, but is not limited to, one or more fish 106, crustacean, feed pellets, predatory animals, and the like. However, it should be appreciated that the sensor measurement acquisition and analysis systems disclosed herein may acquire and/or analyze sensor data regarding any desired or suitable “object” in accordance with operations of the systems as disclosed herein. Further, it should be recognized that although specific sensors are described below for illustrative purposes, various sensor systems may be implemented in the systems described herein without departing from the scope of this disclosure.

In various embodiments, the first sensor system 102a includes one or more observation sensors configured to observe underwater objects and capture measurements associated with one or more underwater object parameters. Underwater object parameters, in various embodiments, include one or more parameters corresponding to observations associated with (or any characteristic that may be utilized in defining or characterizing) one or more underwater objects within the marine enclosure 108. Such parameters may include, without limitation, physical quantities which describe physical attributes, dimensioned and dimensionless properties, discrete biological entities that may be assigned a value, any value that describes a system or system components, time and location data associated with sensor system measurements, and the like.

For ease of illustration and description, FIG. 1 is described here in the context of underwater objects including one or more fish 106. However, those skilled in the art will appreciate that the marine enclosure 108 may include any number of types and individual units of underwater objects. For embodiments in which the underwater objects include one or more fish 106, an underwater object parameter includes one or more parameters characterizing individual fish 106 and/or an aggregation of two or more fish 106. As will be appreciated, fish 106 do not remain stationary within the marine enclosure 108 for extended periods of time while awake and will exhibit variable behaviors such as swim speed, schooling patterns, positional changes within the marine enclosure 108, density of biomass within the water column of the marine enclosure 108, size-dependent swimming depths, food anticipatory behaviors, and the like.

In some embodiments, an underwater object parameter with respect to an individual fish 106 encompasses various individualized data including but not limited to: an identification (ID) associated with an individual fish 106, movement pattern of that individual fish 106, swim speed of that individual fish 106, health status of that individual fish 106, distance of that individual fish 106 from a particular underwater location, and the like. In some embodiments, an underwater object parameter with respect to two or more fish 106 encompasses various group descriptive data including but not limited to: schooling behavior of the fish 106, average swim speed of the fish 106, swimming pattern of the fish 106, physical distribution of the fish 106 within the marine enclosure 108, and the like.

A processing system 110 receives data generated by the one or more sensor systems 102 (e.g., sensor data sets 112) for storage, processing, and the like. As shown, the one or more sensor systems 102 includes a first sensor system 102a having one or more sensors configured to monitor underwater objects and generate data associated with at least a first underwater object parameter. Accordingly, in various embodiments, the first sensor system 102a generates a first sensor data set 112a and communicates the first sensor data set 112a to the processing system 110. In various embodiments, the one or more sensor systems 102 includes a second sensor system 102b positioned proximate the marine enclosure 108 and configured to monitor the environment 104 within which one or more sensors of the second sensor system 102b are positioned. Similarly, the second sensor system 102b generates a second sensor data set 112b and communicates the second sensor data set 112 to the processing system 110.

In some embodiments, the one or more sensors of the second sensor system 102b are configured to monitor the environment 104 below the water surface and generate data associated with an environmental parameter. In particular, the second sensor system 102b of FIG. 1 includes one or more hydroacoustic sensors configured to observe fish behavior and capture acoustic measurements. For example, in various embodiments, the hydroacoustic sensors are configured to capture acoustic data corresponding to the presence (or absence), abundance, distribution, size, and behavior of underwater objects (e.g., a population of fish 106 as illustrated in FIG. 1). Further, in various embodiments, the second sensor system 102b may be used to monitor an individual fish, multiple fish, or an entire population of fish within the marine enclosure 108. Such acoustic data measurements may, for example, be used to identify fish positions within the water.

In various embodiments, the one or more sensors of the second sensor system 102b include one or more of a passive acoustic sensor and/or an active acoustic sensor (e.g., an echo sounder and the like). In various embodiments, the second sensor system 102b is an acoustic sensor system that utilizes active sonar systems in which pulses of sound are generated using a sonar projector including a signal generator, electro-acoustic transducer or array, and the like. Although FIG. 1 only shows a single hydroacoustic sensor for ease of illustration and description, persons of ordinary skill in the art having benefit of the present disclosure should appreciate that the second sensor system 102b can include any number of and/or any arrangement of hydroacoustic sensors within the environment 104 (e.g., sensors positioned at different physical locations within the environment, multi-sensor configurations, and the like).

In some embodiments, the second sensor system 102b utilizes active sonar systems in which pulses of sound are generated using a sonar projector including a signal generator, electro-acoustic transducer or array, and the like. Active acoustic sensors conventionally include both an acoustic receiver and an acoustic transmitter that transmit pulses of sound (e.g., pings) into the surrounding environment 104 and then listens for reflections (e.g., echoes) of the sound pulses. It is noted that as sound waves/pulses travel through water, it will encounter objects having differing densities or acoustic properties than the surrounding medium (i.e., the underwater environment 104) that reflect sound back towards the active sound source(s) utilized in active acoustic systems. For example, sound travels differently through fish 106 (and other objects in the water such as feed pellets) than through water (e.g., a fish's air-filled swim bladder has a different density than water). Accordingly, differences in reflected sound waves from active acoustic techniques due to differing object densities may be accounted for in the detection of aquatic life and estimation of their individual sizes or total biomass. It should be recognized that although specific sensors are described below for illustrative purposes, various hydroacoustic sensors may be implemented in the systems described herein without departing from the scope of this disclosure.

The active sonar system may further include a beamformer (not shown) to concentrate the sound pulses into an acoustic beam covering a certain search angle. In some embodiments, the second sensor system 102b measures distance through water between two sonar transducers or a combination of a hydrophone (e.g., underwater acoustic microphone) and projector (e.g., underwater acoustic speaker). The second sensor system 102b includes sonar transducers (not shown) for transmitting and receiving acoustic signals (e.g., pings). To measure distance, one transducer (or projector) transmits an interrogation signal and measures the time between this transmission and the receipt of a reply signal from the other transducer (or hydrophone). The time difference, scaled by the speed of sound through water and divided by two, is the distance between the two platforms. This technique, when used with multiple transducers, hydrophones, and/or projectors calculates the relative positions of objects in the underwater environment 104.

In other embodiments, the second sensor system 102b includes an acoustic transducer configured to emit sound pulses into the surrounding water medium. Upon encountering objects that are of differing densities than the surrounding water medium (e.g., the fish 106), those objects reflect back a portion of the sound towards the sound source (i.e., the acoustic transducer). Due to acoustic beam patterns, identical targets at different azimuth angles will return different echo levels. Accordingly, if the beam pattern and angle to a target is known, this directivity may be compensated for. In various embodiments, split-beam echosounders divide transducer faces into multiple quadrants and allow for location of targets in three dimensions. Similarly, multi-beam sonar projects a fan-shaped set of sound beams outward from the second sensor system 102b and record echoes in each beam, thereby adding extra dimensions relative to the narrower water column profile given by an echosounder. Multiple pings may thus be combined to give a three-dimensional representation of object distribution within the water environment 104.

In some embodiments, the one or more hydroacoustic sensors of the second sensor system 102b includes a Doppler system using a combination of cameras and utilizing the Doppler effect to monitor the appetite of salmon in sea pens. The Doppler system is located underwater and incorporates a camera, which is positioned facing upwards towards the water surface. In various embodiments, there is a further camera for monitoring the surface of the pen. The sensor itself uses the Doppler effect to differentiate pellets from fish. In other embodiments, the one or more hydroacoustic sensors of the second sensor system 102b includes an acoustic camera having a microphone array (or similar transducer array) from which acoustic signals are simultaneously collected (or collected with known relative time delays to be able to use phase different between signals at the different microphones or transducers) and processed to form a representation of the location of the sound sources. In various embodiments, the acoustic camera also optionally includes an optical camera.

In various embodiments, the one or more sensor systems 102 is communicably coupled to the processing system 110 via physical cables (not shown) by which data (e.g., sensor data sets 112) is communicably transmitted from the one or more sensor systems 102 to the processing system 110. Similarly, the processing system 110 is capable of communicably transmitting data and instructions via the physical cables to the one or more sensor systems 102 for directing or controlling sensor system operations. In other embodiments, the processing system 110 receives one or more of the sensor data sets 112 via, for example, wired-telemetry, wireless-telemetry, or any other communications link for processing, storage, and the like.

The processing system 110 includes one or more processors 114 coupled with a communications bus (not shown) for processing information. In various embodiments, the one or more processors 114 include, for example, one or more general purpose microprocessors or other hardware processors. By way of non-limiting example, in various embodiments, the processing system 110 may be any computer system, such as a workstation, desktop computer, server, laptop, handheld computer, tablet computer, mobile computing or communication device, or other form of computing or telecommunications device that is capable of communication and that has sufficient processor power and memory capacity to perform the operations described herein.

The processing system 110 also includes one or more storage devices 116 communicably coupled to the communications bus for storing information and instructions. In some embodiments, the one or more storage devices 116 includes a magnetic disk, optical disk, or USB thumb drive, and the like for storing information and instructions. In various embodiments, the one or more storage devices 116 also includes a main memory, such as a random-access memory (RAM), cache and/or other dynamic storage devices, coupled to the communications bus for storing information and instructions to be executed by the one or more processors 114. The main memory may be used for storing temporary variables or other intermediate information during execution of instructions to be executed by the one or more processors 114. Such instructions, when stored in storage media accessible by the one or more processors 114, render the processing system 110 into a special-purpose machine that is customized to perform the operations specified in the instructions.

The processing system 110 also includes a communications interface 118 communicably coupled to the communications bus. The communications interface 118 provides a multi-way data communication coupling configured to send and receive electrical, electromagnetic or optical signals that carry digital data streams representing various types of information. In various embodiments, the communications interface 118 provides data communication to other data devices via, for example, a network 120.

Users may access system 100 via remote platform(s) 122. For example, in some embodiments, the processing system 110 may be configured to communicate with one or more remote platforms 122 according to a client/server architecture, a peer-to-peer architecture, and/or other architectures via the network 120. The network 120 may include and implement any commonly defined network architecture including those defined by standard bodies. Further, in some embodiments, the network 120 may include a cloud system that provides Internet connectivity and other network-related functions. Remote platform(s) 122 may be configured to communicate with other remote platforms via the processing system 110 and/or according to a client/server architecture, a peer-to-peer architecture, and/or other architectures via the network 120.

A given remote platform 122 may include one or more processors configured to execute computer program modules. The computer program modules may be configured to enable a user associated with the given remote platform 122 to interface with system 100, external resources 124, and/or provide other functionality attributed herein to remote platform(s) 122. External resources 124 may include sources of information outside of system 100, external entities participating with system 100, and/or other resources. In some implementations, some or all of the functionality attributed herein to external resources 124 may be provided by resources included in system 100.

In some embodiments, the processing system 110, remote platform(s) 122, and/or one or more external resources 124 may be operatively linked via one or more electronic communication links. For example, such electronic communication links may be established, at least in part, via the network 120. It will be appreciated that this is not intended to be limiting, and that the scope of this disclosure includes implementations in which the processing system 110, remote platform(s) 122, and/or external resources 124 may be operatively linked via some other communication media. Further, in various embodiments, the processing system 110 is configured to send messages and receive data, including program code, through the network 120, a network link (not shown), and the communications interface 118. For example, a server 126 may be configured to transmit or receive a requested code for an application program through via the network 120, with the received code being executed by the one or more processors 114 as it is received, and/or stored in storage device 116 (or other non-volatile storage) for later execution.

As previously described, the processing system 110 receives one or more sensor data sets 112 (e.g., first sensor data set 112a, second sensor data set 112b, and stores the sensor data sets 112 at the storage device 116 for processing. In various embodiments, the sensor data sets 112 include data indicative of one or more conditions at one or more locations at which their respective sensor systems 102 are positioned. In some embodiments, the first sensor data set 112a and the second sensor data set 112b include sensor data indicative of, for example, movement of one or more objects, orientation of one or more objects, swimming pattern or swimming behavior of one or more objects, jumping pattern or jumping behavior of one or more objects, any activity or behavior of one or more objects, any underwater object parameter, and the like.

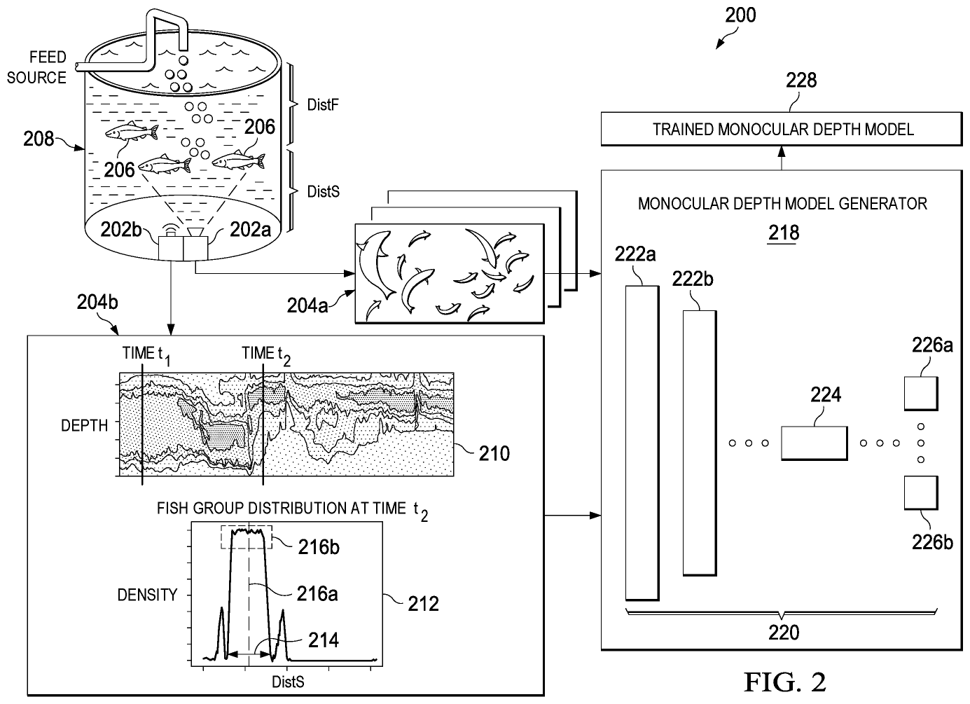

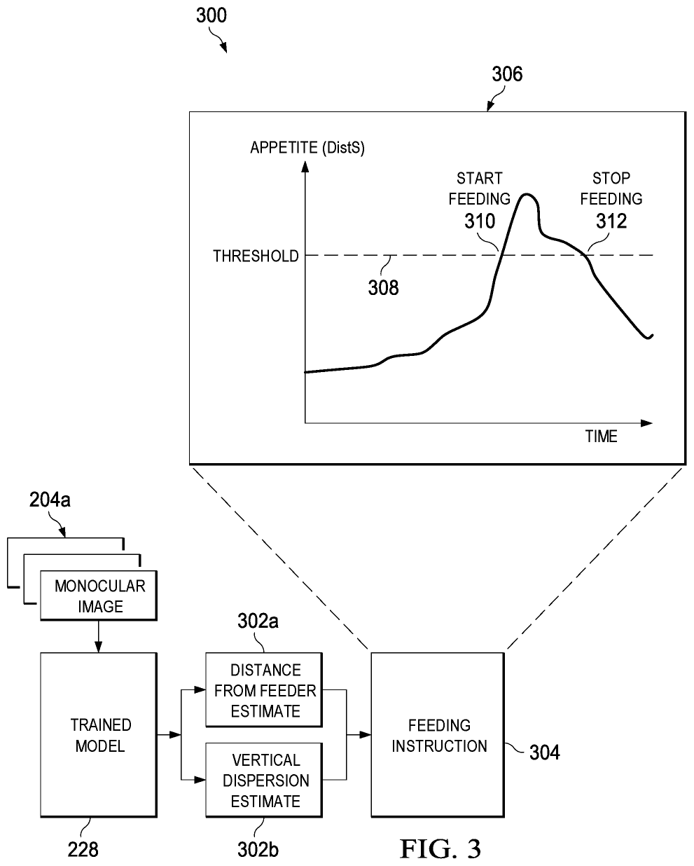

As will be appreciated, environmental conditions will vary over time within the relatively uncontrolled environment within which the marine enclosure 108 is positioned. Further, fish 106 freely move about and change their positioning and/or distribution within the water column (e.g., both vertically as a function of depth and horizontally) bounded by the marine enclosure 108 due to, for example, time of day, schooling patterns, resting periods, feeding periods associated with hunger, and the like. Accordingly, in various embodiments and as described in more detail below with respect to FIGS. 2-3, the system 100 provides at least a portion of the sensor data 112 corresponding to underwater object parameters (e.g., first sensor data set 112a and second sensor data set 112b) as training data for generating a trained monocular depth estimation model 128 using machine learning techniques and neural networks. One or more components of the system 100, such as the processor 110, may be periodically trained to improve the performance of sensor system 102 measurements by training an acoustics-augmented monocular depth estimation model capable of generating depth estimation metrics as output using input of monocular images. Further, in various embodiments, outputs from the trained monocular depth estimation model 128 related to depth estimation metrics may be provided, for example, as feeding instructions to a feed controller system 130 for controlling the operations (e.g., dispensing of feed related to meal size, feed distribution, meal frequency, feed rate, etc.) of automatic feeders, feed cannons, and the like.

FIG. 2 is a diagram illustrating a system 200 with an example network architecture for performing a method of acoustics-augmented monocular depth estimation in accordance with some embodiments. The system 200 includes an underwater imaging sensor 202a (e.g., first sensor system 102a of FIG. 1) capturing still images and/or record moving images (e.g., video data). In various embodiments, the imaging sensor 202a includes, for example, one or more video cameras, photographic cameras, stereo cameras, or other optical sensing devices configured to capture imagery periodically or continuously. The imaging sensor 202a is directed towards the surrounding environment and configured to capture a sequence of images 204a (e.g., video frames) of the environment and any objects in the environment (including fish 206 within the marine enclosure 208 and the like).

It should be noted that the various operations are described here in the context of monocular images 204a. However, it should be recognized that the operations described herein may similarly be implemented with any type of imaging sensor and its associated imagery without departing from the scope of this disclosure. For example, in various embodiments, the imaging sensor 202a includes, but is not limited to, any of a number of types of optical cameras (e.g., RGB and infrared), thermal cameras, range- and distance-finding cameras (e.g., based on acoustics, laser, radar, and the like), stereo cameras, structured light cameras, ToF cameras, CCD-based cameras, CMOS-based cameras, machine vision systems, light curtains, multi- and hyper-spectral cameras, thermal cameras, and the like. Such imaging sensors of the imaging sensor 202a may be configured to capture, single, static images and/or also video images in which multiple images may be periodically captured.

Further, an acoustic sensor 202b (e.g., second sensor system 102b of FIG. 1) is directed towards the surrounding environment and captures acoustic data 204b corresponding to the presence (or absence), abundance, distribution, size, and behavior of underwater objects (e.g., a population of fish 206 as illustrated in FIG. 2). Further, in various embodiments, the acoustic sensor 202b monitors an individual fish, multiple fish, or an entire population of fish within the marine enclosure 208. Such acoustic data measurements may, for example, be used to identify fish positions within the water. In some embodiments, such as illustrated in FIG. 2, the imaging sensor 202a and the acoustic sensor 202b are positioned side-by-side at approximately the same position at the bottom of the marine enclosure 208 for recording the behavior and location of the population of fish 206. In various embodiments, the sequence of images 204a and the acoustic data 204b include time tags or other metadata that allow the imagery and acoustic data to be synchronized or otherwise matched in time relative to each other. In some embodiments, the imaging sensor 202a and the acoustic sensor 202b simultaneously capture measurement data of a target (e.g., fish 206 within the marine enclosure 208).

As will be appreciated, recording of quality depth data in underwater environments is a challenging task due to variable underwater conditions including, for example, variable and severe weather conditions, changes to water conditions, turbidity, changes in ambient light resulting from weather and time-of-day changes, and the like. Further, objects within the marine enclosure 208, such as fish 206 and administered feed pellets, do not remain stationary and instead exhibit movement through the marine enclosure 208 over time. Additionally, the field of view of any individual imaging sensor 202a only captures a subset of the total population of fish 206 within the marine enclosure 208 at any given point in time. That is, the field of view only provides a fractional view of total biomass, water surface, and water column volume of a marine enclosure 208 within each individual image. Accordingly, conventional depth estimation techniques such as stereoscopic depth determinations may not accurately provide context as to the locations of fish biomass.

In various embodiments, the system 200 generates a trained monocular depth model that receives monocular images (which do not inherently provide depth data and/or only include minimal depth cues such as relative size differences between objects, and for any given 2D image of a scene, there are various 3D scene structures explaining the 2D measurements exactly) as input and generate one or more monocular depth estimate metrics as output. In various embodiments, the acoustic data 204b includes hydroacoustic signals (shown as an echogram image 210) resulting from, for example, emitted sound pulses and returning echo signals from different targets within the marine enclosure 208 that correspond to fish 206 positions (e.g., dispersion of fish within the water column and density of fish at different swim depths) over time.

For a given time series, the imaging sensor 202a captures location information including the locations of individual fish 206 within its field of view and the acoustic sensor 202b detects signals representative of fish 206 positions over time. The system 200 extracts, in various embodiments, fish group distribution data 212 at each time step t (e.g., any of a variety of time ranges including milliseconds, seconds, minutes, and the like that is synchronized in time with respect to one or more of the sequence of images 204a). As illustrated in FIG. 2, the fish group distribution data 212 includes a mapping of fish biomass density as a function of distance from the water surface (e.g., DistF corresponding to a distance between vertical biomass center metric and a feed source at the water surface). Correlated with the DistF distance is a distance between the vertical biomass center metric and a sensor (e.g., DistS). At any given time t, the system 200 extracts information corresponding to the echogram image 210 to determine fish density distribution across DistS (or DistF). For example, at time t₂, the y-axis depth values of the echogram image 210 (e.g., DistS) is translated to the x-axis of fish group distribution data 212 for mapping of fish density distribution across various depth levels.

In some embodiments, the fish group distribution data 212 includes a vertical biomass center metric representing a distance DistS at which the average biomass is located within the vertical water column of the marine enclosure 208 away from sensors 202a, 202b. In some embodiments, the vertical biomass center metric is a single depth value around which total fish biomass is centered. Further, due to the single depth value of vertical biomass center sometimes being insufficient in providing location information, in some embodiments the fish group distribution data 212 also includes a vertical dispersion metric (e.g., VertR vertical spanning of the fish group) corresponding to a dispersion of fish relative to the vertical biomass center for discriminating between instances in which fish 206 are broadly dispersed within the water column (e.g., at time t₁) versus instances in which fish 206 are densely located within a particular depth range within the water column (e.g., at time t₂). In other embodiments, such as illustrated in FIG. 2, the vertical biomass center metric is a depth range 214 within which a predetermined threshold of total fish biomass (e.g., 70% of total biomass within the marine enclosure 208) is located.

Many conventional depth estimation techniques formulate depth estimation as a structured regression task in which depth estimation is trained by iteratively minimizing a loss function between predicted depth values and ground-truth depth values, and aims to output depth as close to the actual depths as possible. However, it is difficult to regress the depth value of input data to be exactly the ground-truth value. Further, it is difficult acquire such per-pixel ground truth depth data, particularly in natural underwater scenes featuring object movement and reflections. Instead of training a model to predict the per-pixel scene depth value of a point (e.g., continuous regression task due to the continuous property of depth values) or predicting of depth ranges (e.g., pixel-wise depth classification task that discretizes continuous depth values into discrete bins), system 200 trains a monocular depth model that outputs one or more monocular depth estimate metrics, as discussed in more detail herein.

In various embodiments, a monocular depth model generator 218 receives the sequence of images 204a and the acoustic data 204b as input to a convolutional neural network (CNN) 220 including a plurality of convolutional layer(s) 222, pooling layer(s) 224, fully connected layer(s) 226, and the like. The CNN 220 formulates monocular depth estimation as a regression task and learns a relationship (e.g., translation) between acoustic data and camera images. At training time, the CNN 220 has access to a monocular image 204a and acoustic data 204b captured at substantially the same moment in time. Instead of directly predicting per-pixel depth, the CNN 220 replaces use of explicit ground truth per-pixel depth data during training with acoustics data 204b that provides depth cues in the form of, for example, fish group distribution data 212 representing population-wide metrics corresponding to positioning of fish 206 within the marine enclosure 208 (e.g., as opposed to depth data of each individual fish 206 or depth data for each pixel of the monocular image 204a).

In various embodiments, a softmax layer is removed from the CNN 220 to configure the CNN 220 for regression instead of classification tasks. Additionally, the last fully connected layer 226 includes N number of output units corresponding to N number of monocular depth estimate metrics to be generated by the CNN 220. As illustrated in FIG. 2, the monocular depth estimate metrics include a prediction of a distance-from-feeder estimate 226a (e.g., estimation of DistF distance as the feeder is approximately positioned at or proximate the water surface, or the related DistS distance as sensors 202a, 202b are often stationary and therefore distance between sensors and the feed source is a fixed value) of the vertical biomass center and a vertical dispersion estimate 226b (e.g., estimation of VertR vertical spanning of the fish group) relative to the vertical biomass center. In this manner, the CNN 220 learns the relationship between input monocular images 204a and the corresponding monocular depth estimate metrics of a distance-from-feeder estimate 226a and a vertical dispersion estimate 226b, as embodied in a trained monocular depth model 228, without requiring supervision in the form of pixel-aligned ground truth depth at training time (i.e., does not use each monocular image pixel's corresponding target depth values at training).

In some embodiments, the CNN 220 includes a softmax layer (not shown) that converts the output of the last layer in the neural network (e.g., last fully connected layer 226 having N number of monocular depth estimate metrics as illustrated in FIG. 2) into a probability distribution corresponding to whether fish 206 within the marine enclosure 208 are positioned within a “feeding area” of the vertical water column (e.g., a predetermined area) that is indicative of hunger and/or receptiveness to ingest feed if administered.

It should be recognized that although FIG. 2 is described in the specific context of the illustrated network architecture, the system 200 may perform monocular depth estimation training and inference using various neural network configurations without departing from the scope of this disclosure. By way of non-limiting examples, in various embodiments, the system 200 may use neural network models such as AlexNet, VGG, ResNet, SqueezeNet, DenseNet, Inception, GoogLeNet, ShuffleNet, MobileNet, ResNeXt, Wide ResNet, MNASNet, and various other convolutional neural networks, recurrent neural networks, recursive neural networks, and various other neural network architectures.

Referring now to FIG. 3 and with continued reference to FIG. 2, illustrated is a diagram 300 of controlling feeding operations based on monocular depth estimation in accordance with some embodiments. In various embodiments, the trained monocular depth model 228 receives one or more monocular images 204a and generates a depth estimation output 302 for each monocular image 204a. As illustrated in FIG. 3, in some embodiments, the depth estimation output 302 includes a distance-from-feeder estimate 302a and a vertical dispersion estimate 302b (such as provided by the output(s) of the last fully connected layer 226 of distance-from-feeder estimate 226a and a vertical dispersion estimate 226b of FIG. 2). The depth estimation output 302 is included as basis for determining a feeding instruction 304 for guiding feeding operations.

In various embodiments, using DistF/DistS as an example for ease of illustration, the feeding instruction 304 includes the distance-from-feeder estimate 302a based at least in part on DistS corresponding to whether a sufficient number of fish are positioned within the feeding area (e.g., water volume directly underneath the feeder) to begin feeding or whether a sufficient number of fish have left the feeding area such that feeding should be slowed or stopped. As illustrated in block 306, larger DistS values (and therefore smaller DistF values corresponding to fish 206 population being positioned closer to the water surface) is, in various embodiments, a proxy for increased appetite as fish 206 begin swimming closer to the feed source.

The DistS-based feeding instruction 304 is illustrated in block 306 as a function of time. After the DistS value exceeds a predefined threshold 308, the feeding instruction 304 indicates that fish 206 have an increased level of appetite and begin swimming closer to a feed source proximate the water surface. The closer the fish group is to the feed blower, the higher their appetite is estimated to be; accordingly, the feeding instruction 304 provides a start feeding signal 310. Similarly, as fish 206 consume food and begin swimming away from the feed source, the feeding instruction 304 indicates that fish 206 have a decreased level of appetite and provides a stop feeding signal 312.

In various embodiments, the feeding instruction 304 also incorporates other metrics in appetite determination including the vertical dispersion estimate 302b, other depth estimation output(s) 302 corresponding to depth-related metrics not explicitly described here, and the like. For example, a large VertR value indicates that individual fish 206 in the marine enclosure 208 are widely dispersed throughout the marine enclosure 208 and have a large variation in appetite for a given time period (e.g., some fish might be full while others might still be very hungry). When feeding such a group of fish with a wide appetite variation, a feeder should consider reducing the rate or quantity of pellets administered so as to be less likely to waste the feed. Conversely, when the feeding instruction 304 is indicative of a small VertR and large DistS, a large portion of total fish 206 biomass is gathered close to the feed source. When feeding such a group of fish with a narrow appetite variation (e.g., a large number of the fish 206 have a high appetite), a feeder should consider increasing the feeding rate or quantity of pellets administered. In various embodiments, the feeding instruction 304 is provided to a feed controller system 314 for controlling the operations (e.g., dispensing of feed related to meal size, feed distribution, meal frequency, feed rate, etc.) of automatic feeders, feed cannons, and the like. The feed controller system 314 determines, in various embodiments, an amount, rate, frequency, timing and/or volume of feed to provide to the fish 206 in marine enclosure 208 based at least in part on the depth estimation output(s) 302 and the feeding instruction 304.

Accordingly, the systems and methods described herein provide for training an image-only learned monocular depth estimation model that is capable of performing single image depth estimation tasks despite absence of per-pixel ground truth depth data at training time. In this manner, by enriching camera images with other synchronized data sources (including acoustics data which provides biomass density and positional data within water column, total individual fish count info, average individual weight, min/max individual weight, and the like), the dimensionality of monocular image data may be improved. The approach integrates data from acoustic sonar and utilizes deep learning techniques to estimate distance of fish groups from feed sources, the being a proxy of fish appetite.

As discussed above, acoustic data provide targets corresponding to the input images for training the monocular depth estimation model to generate depth-related estimation outputs from input monocular images and extending depth estimation capabilities to mono-vision image systems that do not inherently provide depth data. That is, the acoustics-data-trained monocular depth estimation model provides improved biomass positional data to sensor systems that traditionally does not provide such information. The techniques described herein may replace expensive known systems, including those utilizing stereoscopic cameras, LIDAR sensors, and the like for detecting depth within an environment, thereby lower cost implementation of feeding control.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
receiving a plurality of monocular images corresponding to images of fish within a marine enclosure;
receiving acoustic data synchronized in time relative to the plurality of images; and
providing the plurality of images and the acoustic data to a convolutional neural network (CNN) for training a monocular depth model, wherein the monocular depth model is trained to generate, based on the received plurality of monocular images and the acoustic data, a distance-from-feeder estimate of a vertical biomass center.

2. The method of claim 1, wherein receiving acoustic data further comprises:
receiving an echogram corresponding to fish position over a period of time within the marine enclosure; and
determining, for each of a plurality of time instances within the period of time, a vertical dispersion metric corresponding to a dispersion of fish relative to the vertical biomass center.

3. The method of claim 2, wherein the monocular depth model is further trained to generate, based on the received plurality of monocular images and the acoustic data, a vertical dispersion estimate.

4. The method of claim 3, wherein the monocular depth model is configured to generate, based on a single monocular image as input, a monocular depth estimation output including the distance-from-feeder estimate and the vertical dispersion estimate.

5. The method of claim 4, further comprising:
determining, based at least in part on the monocular depth estimation output, a feeding instruction specifying an amount of feed to provide.

6. The method of claim 5, further comprising:
providing the feeding instruction to guide operations of a feed controller system.

7. A non-transitory computer readable medium embodying a set of executable instructions, the set of executable instructions to manipulate at least one processor to:
receive a plurality of monocular images corresponding to images of fish within a marine enclosure;
receive acoustic data synchronized in time relative to the plurality of monocular images; and
provide the plurality of monocular images and the acoustic data to a convolutional neural network (CNN) for training a monocular depth model, wherein the monocular depth model is trained to generate, based on the received plurality of monocular images and the acoustic data, a distance-from-feeder estimate of a vertical biomass center.

8. The non-transitory computer readable medium of claim 7, further embodying executable instructions to manipulate at least one processor to:
receive an echogram corresponding to fish position over a period of time within the marine enclosure; and
determine, for each of a plurality of time instances within the period of time, a vertical dispersion metric corresponding to a dispersion of fish relative to the vertical biomass center.

9. The non-transitory computer readable medium of claim 7, further embodying executable instructions to manipulate at least one processor to:
generate, based on the received plurality of monocular images and the acoustic data, a vertical dispersion estimate.

10. The non-transitory computer readable medium of claim 9, further embodying executable instructions to manipulate at least one processor to:
generate, based on the received plurality of monocular images and the acoustic data, a vertical dispersion estimate.

11. The non-transitory computer readable medium of claim 10, further embodying executable instructions to manipulate at least one processor to:
generate, based on a single monocular image as input, a monocular depth estimation output including the distance-from-feeder estimate and the vertical dispersion estimate.

12. The non-transitory computer readable medium of claim 10, further embodying executable instructions to manipulate at least one processor to:
determine, based at least in part on the monocular depth estimation output, a feeding instruction specifying an amount of feed to provide.

13. The non-transitory computer readable medium of claim 12, further embodying executable instructions to manipulate at least one processor to:
provide the feeding instruction to guide operations of a feed controller system.

14. A system, comprising:
an imaging sensor configured to capture a set of monocular images of fish within a marine enclosure; and
a processor configured to:
provide the set of monocular images to a monocular depth model for generating a distance-from-feeder estimate of a vertical biomass center.

15. The system of claim 14, wherein the monocular depth model is trained to generate, based on a single monocular image as input, a monocular depth estimation output including the distance-from-feeder estimate and the vertical dispersion estimate corresponding to a dispersion of fish relative to the vertical biomass center.

16. The system of claim 15, wherein the monocular depth model is configured to generate, based on the single monocular image as input, a monocular depth estimation output including the distance-from-feeder estimate and the vertical dispersion estimate.

17. The system of claim 16, wherein the processor is further configured to:
determine, based at least in part on the monocular depth estimation output, a feeding instruction specifying an amount of feed to provide.

18. The system of claim 17, wherein the processor is further configured to:
provide the feeding instruction to guide operations of a feed controller system.
